(19) United States
(12) Patent Application Publication
(10) Pub. No.: US 2026/0361796 A1
(43) Pub. Date: Nov. 12, 2026

(54) MECHANISMS FOR IMPLEMENTING A LOW-LATENCY STORE

(71) Applicant: Salesforce, Inc., San Francisco, CA (US)

(72) Inventors: Sreeram Kumar Garlapati, Bothell, WA (US); Tapas Kumar Nayak, Redmond, WA (US); Anil Kumar Nori, Redmond, WA (US); Jan Finis, Munich (DE)

(21) Appl. No.: 19/200,466

(22) Filed: May 6, 2025

(51) Int. Cl. H04L 67/50; G06F 9/445

(52) U.S. Cl. CPC H04L 67/50; G06F 9/44505

(57) ABSTRACT

A computer system may access configuration policies that determine what data from different data ecosystems to store in a low-latency store. At least two of the data ecosystems may include different database systems that store data differently. The computer system may execute worker processes to load particular data from the data ecosystems into the low-latency store based on the configuration policies. The particular data may include unstructured data and structured data, and the unstructured data may include files loaded by the worker processes using different approaches that account for different file sizes. The computer system may also service requests from a client application for data of the data ecosystems. The servicing may include accessing and returning at least a portion of the data from the low-latency store instead of those data ecosystems. The low-latency store may provide lower latency response times to data access requests than the data ecosystems.

### BACKGROUND

### Technical Field

This disclosure relates generally to computer systems and, more specifically, to various mechanisms for implementing a low-latency store that is capable of serving diverse types of data that originate from different data ecosystems.

### Description of the Related Art

Enterprises routinely manage a mix of structured data and unstructured data.

Structured data refers to data that is organized in a consistent, standardized format that often allows for it to be easily searched, processed, and analyzed by computers. It is typically tabular with rows and columns that define data attributes. For example, a table with customer information, where each row represents a customer and the columns include fields like “ID,” “name,” “email,” and “purchase date,” is structured data. This organization allows for efficient storage, retrieval, and manipulation, often leveraging tools such as Structured Query Language (SQL) for databases. Structured data contrasts with unstructured data that lacks a predefined format or structure and may be harder to process systematically. Examples of unstructured data include videos, audio files, journals, legal documents, sensor data, and the unstructured text of web pages. Despite its complexity, unstructured data powers a range of applications, such image recognition, voice assistants, and content recommendation.

### BRIEF DESCRIPTION OF THE DRAWINGS

FIG. 1 is a block diagram illustrating one embodiment of a system comprising a storage layer having a low-latency store.

FIG. 2 is a block diagram illustrating one embodiment of a low-latency store comprising a data loader that loads data from a high-latency layer based on configuration policies.

FIG. 3 is a block diagram illustrating one embodiment of a file addressing approach implemented by a low-latency store for loading files.

FIG. 4 is a block diagram illustrating one embodiment of a block addressing approach implemented by a low-latency store for loading files.

FIG. 5 is a block diagram illustrating one embodiment of an approach implemented by a low-latency store for loading different types of structured data.

FIG. 6 is a diagram illustrating one embodiment of a low-latency store servicing a data request from a client.

FIG. 7 is a flow diagram illustrating an example method relating to serving data from a low-latency store that originates from different data ecosystems.

FIG. 8 is a block diagram illustrating elements of a computer system for implementing various systems described in the present disclosure, according to some embodiments.

### DETAILED DESCRIPTION

Cloud platforms often manage diverse types of data in order to provide services to users of those platforms. For example, a cloud platform may store structured data and unstructured data, such as customer records, emails, PDFs (Portable Document Format), and telemetry data. Managing these diverse types of data typically leads to silos of data stacks (also referred to as data ecosystems) being created over time based on each of these types. Broadly speaking, a data ecosystem is a collection of tools and technologies used cohesively to collect, store, process, and analyze data. Separate data ecosystems often emerge to handle different use cases by adopting specific data stacks trailed to those use cases. For example, a first data ecosystem may include a distributed storage system for storing relational data and a relational database system that manages that relational data, while a second data ecosystem includes a distributed storage system for storing columnar data and a columnar database system that manages that data. The first data ecosystem may be better suited for transactional workloads (e.g., performed by banking systems) while the second data ecosystem may be better suited for analytical workloads. While data ecosystems can be optimized for different workflows, they typically do not integrate well with one another such that one data ecosystem can easily access and use the data of another data ecosystem.

Further, certain applications may use structured data and unstructured data to facilitate their functionality. For example, in order for a large language model (LLM)-based agent to serve users effectively, it may need to access unstructured data, such as audio files, video, and images, and structured data, such as columnar data about users. These diverse types of data may be stored by different data ecosystems, making it more difficult and complex for the agent to access the data. Moreover, these different data ecosystems may have performance properties that are not suitable for the requirements of the agent. For example, the LLM-based agent may be a low-latency application that expects low-latency responses when accessing data. But that data may be stored by a data ecosystem that cannot consistently provide the data quick enough to meet that agent's low-latency requirements. While an LLM-based agent is discussed in this example, other classes of client applications, such as web applications, may rely on accessing structured data and/or unstructured data with low latencies. The present disclosure addresses, among other things, the problem of how to overcome one or more of the deficiencies above, such as how to provide diverse types of data to an application, or a system, that are stored across different data ecosystems while meeting latency requirements.

In various embodiments described below, a system implements a low-latency store that serves as a unified low-latency layer capable of serving diverse types of data that can originate from different data ecosystems. The system may include a query layer and a storage layer that comprises a low-latency layer (having the low-latency store) and a high-latency layer that may store data of the different data ecosystems. The different data ecosystems may include multiple data ecosystems that leverage different database systems that store data differently. In various embodiments, the low-latency store loads both structured and unstructured data from the high-latency layer and leverages a metadata-driven approach to determine what to data to load and how long to store it. The low-latency store may service requests (e.g., from an LLM agent, a web application, or any other custom application) for data of the different data ecosystems. Accordingly, the low-latency store may access and return at least a portion of the requested data instead of the high-latency layer. The low-latency store may provide lower latency response times to data access requests than the high-latency layer, and thus allow for applications (particularly, low-latency applications, such as an LLM agent) to access diverse types of data with low latency, enabling those applications to function more effectively.

Regarding the metadata-driven approach, configuration policies may be specified that drive the low-latency store to load certain data into the low latency store—that is, the policies may determine what data from the different data ecosystems to load into the low-latency store. For example, profile information about customers of a tenant (e.g., a company) of the system may be preemptively loaded from the high-latency layer into the low-latency store as an LLM agent may leverage the information when interacting with the tenant's customers. Tenants may define configuration policies based on one or more factors, such as recency, importance, object types, and other parameters. In various embodiments, the low-latency store implements worker processes to load data from the data ecosystems (the high-latency layer that stores their data) into the low-latency store based on a set of configuration policies. That data can include both unstructured and structured data, and the unstructured data may contain files of different sizes. In various embodiments, the worker processes load these files using different approaches (e.g., a file addressing, consistent hashing approach and a block addressing approach) that account for the different file sizes. Data may also be brought into the low latency store when the query layer 1) writes data (e.g., in response to requests from a low-latency application) and 2) requests data that was not already loaded into the low-latency store.

These techniques may be advantageous over prior approaches as these techniques allow for unstructured and structured data to be accessed from a consolidated place with low latency relative to a higher latency storage that stores the data from different data ecosystems that may not integrate well with each other. As a result, a client application, such as an LLM agent, a web application, or any other type of application that may need to access unstructured data (e.g., audio files, video, and images) and structured data with low latency, is able to do so since, e.g., the low-latency store may use non-volatile memory express (NVMe) drives that allow for it to provide lower latency response times. Furthermore, the low-latency store may be part of the same storage layer as the higher latency storage that stores the data from different data ecosystems. The storage layer may provide a common access endpoint to clients that request data. Since the low-latency store can share the same access endpoint and leverage the same application programming interface used to access the higher latency storage, clients may not need to be programmed to explicitly access the low-latency store—that is, the clients can continue to issue the same access requests that were issued to access data from the higher latency storage. This stands in contrast to an approach in which the low-latency store is implemented as a separate storage layer and thus has a different access point that requires the clients to be programmed to issue correctly formatted requests to that access point, which can burden developers. Moreover, by using configuration policies that can be defined by different tenants of the system to load data into the low-latency store, this may allow for tenant that have different needs to load data that is relevant to their use case. Also, by using different approaches to load files from an underlying data ecosystem, the low-latency store can access and manage files of varying sizes in an efficient manner.

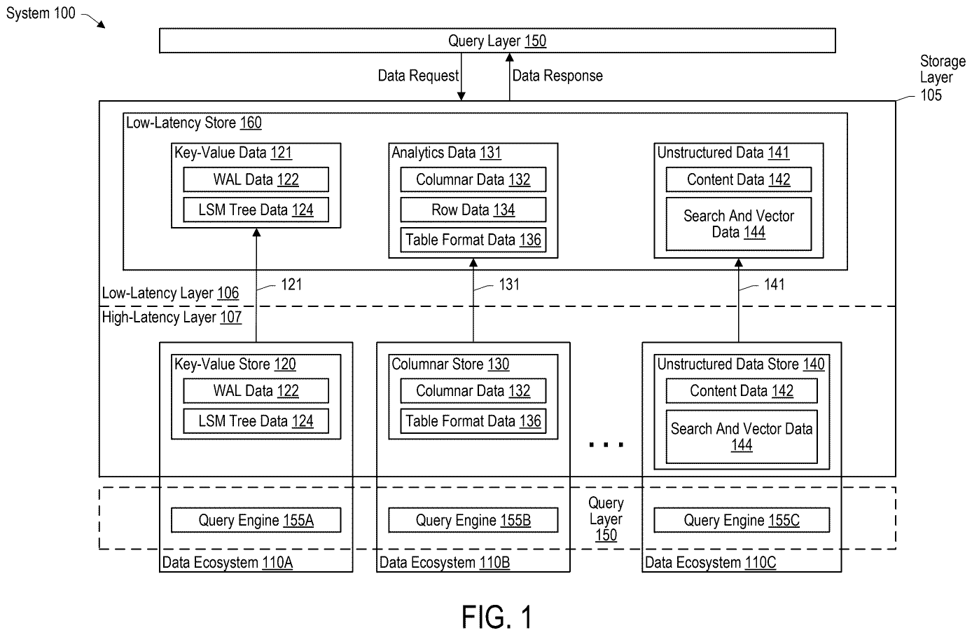

Turning now to FIG. 1, a block diagram of a system 100 is shown. System 100 includes a set of components that may be implemented via hardware or a combination of hardware and software. In the illustrated embodiment, system 100 includes a storage layer 105 and a query layer 150. As further shown, storage layer 105 includes a low-latency layer 106 (having a low-latency store 160) and a high-latency layer 107 (having data ecosystems 110A-C), and query layer 150 includes query engines 155A-C of data ecosystems 110A-C, respectively. As shown, data ecosystem 110A includes a key-value store 120, data ecosystem 110B includes a columnar store 130, and data ecosystem 110C includes an unstructured data store 140. Also as shown, low-latency store 160 includes key-value data 121 (having WAL data 122 and LSM tree data 124), analytics data 131 (having columnar data 132, row data 134, and table format data 136), and unstructured data 141 (having content data 142 and search and vector data 144) obtained from data ecosystems 110A-C, respectively. The illustrated embodiment may be implemented differently than shown. For example, there can be other data ecosystems 110 that store other types of data that can be loaded into low-latency store 160.

System 100, in various embodiments, implements a platform service (e.g., a customer relationship management (CRM) platform service) that allows users of that service to develop, run, and manage applications. System 100 may be a multi-tenant system that provides various functionality to users/tenants hosted by the multi-tenant system. Accordingly, system 100 may execute software routines from various, different users (e.g., providers and tenants of system 100) as well as provide code, web pages, and other data to users, stores, and other entities that are associated with system 100. In various embodiments, system 100 is implemented using a cloud infrastructure that is provided by a cloud provider. Accordingly, components of system 100, such as data ecosystems 110A-C, query layer 150, and low-latency store 160, may utilize the available cloud resources of that cloud infrastructure (e.g., computing resources, storage resources, etc.) in order to facilitate their operation. As an example, software for implementing low-latency store 160 may be stored on a non-transitory computer-readable medium of server-based hardware included in a datacenter of the cloud provider and executed in a virtual machine hosted on that server-based hardware. Various components of system 100, however, may be implemented without the assistance of virtual machines or other deployment technologies such as containerization. In some embodiments, system 100 is implemented using a local or private infrastructure as opposed to a public cloud.

Storage layer 105, in various embodiments, is a component or subsystem within system 100's architecture that is responsible for physically storing and managing data, ensuring data integrity, availability, and efficient retrieval. The data of storage layer 105 may be stored and accessed from different storage mediums, such as hard disk drives (HDDs), solid-state drives (SSDs), and memory (e.g., dynamic random access memory). In various embodiments, storage layer 105 is implemented or distributed across multiple storage servers or nodes, which can be located in different physical locations (e.g., different data centers in different regions). Storage layer 105 may implement replication and/or sharding techniques to replicate and/or distribute data among multiple storage nodes. This distributed paradigm may allow storage layer 105 to manage increasing amounts of data, improve performance via parallel processing and localized data access, and also provide data resilience to safeguard against data loss or corruption.

In various embodiments, storage layer 105 abstracts away the complexities of physical storage from the rest of system 100, allowing higher-level components (e.g., query layer 150) to focus on logical operations rather than the details of how data is stored. For example, for a relational database (e.g., PostgreSQL®), storage layer 105 may manage how rows and indexes are laid out on disk. Storage layer 105 may serve as the persistent data storage for higher-level components of system 100, ensuring that data remains intact even when systems are powered off or restarted or suffer crashes and power failures.

As shown, storage layer 105 includes a low-latency layer 106 and a high-latency layer 107. Low-latency layer 106 is referred to as “low latency” since it (or particularly, low-latency store 160) provides lower latency response times on average to data access requests than high-latency layer 107—that is, low-latency layer 106 is lower latency relative to high-latency layer 107. As an example, low-latency store 160 of low-latency layer 106 may provide responses in under one millisecond (in the order of lower 100's microseconds) in contrast to data ecosystems 110 that may take 100s of milliseconds to provide responses. This ability for low-latency layer 106 to prover lower latency response times may be due, in part, to data being stored on non-volatile memory express (NVMe) drives in low-latency layer 106 while high-latency layer 107 utilizes HDDs to store data. High-latency layer 107 might be implemented using a storage service such as Amazon Simple Storage Service® (S3) while low-latency layer 106 may be implemented using Amazon Elastic Compute Cloud instances (EC2 instances) that are coupled to or can otherwise access NVMe drives.

Data ecosystems 110A-C, in various embodiments, are different silos of data stacks. A data stack may be a collection of tools and technologies that are used to collect, store, process, and analyze data. For example, a data stack may include a storage component that stores data, an ingestion component that ingests data from sources (e.g., Internet of Things (IoT) devices), a transformation component that transforms raw data into a usable format, a query component that can query data from the storage component, and an analytics component that can produce dashboards or create insights on queried data. In various embodiments, data ecosystems 110A-C adopt different data stacks tailored to different use cases, and thus one data ecosystem may be suited for a use case than another data ecosystem. For example, data ecosystems 110A may perform better for transactional workloads than data ecosystems 110B and 110C because data ecosystem 110A uses key-value store 120. In various embodiments, data ecosystems 110A-C can be described as “siloed” relative to each other because they may not integrate well or at all with one another. For example, data ecosystem 110A may not be able to access data from data ecosystem 110B's columnar store 130. This siloed nature may prevent seamless data sharing, collaboration, or integration across data ecosystems 110A-C, which can lead to inefficiencies, inconsistencies, and missed opportunities. As shown in FIG. 1, data ecosystem 110A includes key-value store 120, data ecosystem 110B includes columnar store 130, and data ecosystem 130C includes unstructured data store 140.

Key-value store 120, in various embodiments, is a database that stores data as a set of key-value pairs—each piece of data (the value) is associated with a unique identifier (the key) that can be used to look up that piece of data. A value may range from a string or a number to complex objects, such as JavaScript Object Notation (JSON). Redis™ may be one example of key-value store 120. Key-value store 120 may be optimized for fast lookups, insertions, and updates and also support data partitioning and replication allowing data to be partitioned and/or replicated across multiple storage nodes in a distributed architecture. In various embodiments, key-value store 120 is used to store structured data that is in a row format—that is, the data is organized into rows, where each row may represent a record (e.g., of a table). As shown, key-value store 120 includes write-ahead log (WAL) data 122 and log-structured merge (LSM) tree data 124.

WAL data 122, in various embodiments, includes log records that describe operations (e.g., inserts, updates, etc.) that are performed as a result of executing database transactions. For example, as part of the process of writing a record to key-value store 120 when executing a database transaction, query engine 155A may log the insert of the record (along with enough information to allow for recovery or rolled back if needed) as a log record before the record is persisted. WAL data 122 may thus constitute a transaction log, which may be append-only and continuously receive appends as database transactions do work. By reading WAL data 122, a component (e.g., query engine 155A) may determine an ordering in which database operations were performed, including an ordering in which database transactions were committed in data ecosystem 110A.

LSM tree data 124, in various embodiments, includes data that is associated with LSM tree(s). An LSM tree is a data structure having a hierarchy of levels that each store data, where lower levels may store more data and on slower storage devices than higher levels. A database server may initially write records (e.g., records corresponding to rows in a database table) into a local in-memory cache, particularly into a memtable. Once the memtable becomes full, then the database server may flush records of the memtable to disk as an immutable, sorted file that is typically referred to as a sorted string table (SSTable)—the database server may interact with storage layer 105 to write the SSTable to disk. Over time, those records are rewritten into new SSTables stored in lower levels as the records are merged down the LSM tree via a compaction process. In various embodiments, LSM tree data 124 includes SSTables and other LSM-based structures such as Bloom filters attached to the SSTables, spare indexes, and manifest files that track the overall state of the LSM tree.

Columnar store 130, in various embodiments, is a database that stores data in columns (rather than rows as may be done by key-value store 120). Columnar store 130 may be better suited or optimized for analytical workloads that involve accessing specific fields across many records. Columnar data 132, in various embodiments, includes one or more files (e.g., Apache Parquet files) that store the column data. In various embodiments, columnar data 132 is stored in a single file in which the data is organized into column pages or blocks, where a given page includes the data for one column. The file may also include metadata to navigate these pages. In some embodiments, multiple files are used, where one or more columns (that is, the values under the columns) are bundled into a given file with internal separation. Columnar store 130 may be better suited for analytical workloads since the values of a single column for multiple rows may be accessed from one data block on disk without having to access those rows in their entirety.

In various embodiments, columnar store 130 can also reconstruct rows from columnar data 132 and return the rows in response to an access request for them. Accordingly, row data 134, in various embodiments, includes a set of reconstructed rows. Columnar store 130 further stores table format data 136. Table format data 136, in various embodiments, includes metadata defining table schema, a partitioning scheme, a snapshot history, and/or manifest files that list the data files having columnar data 132, their locations, and stats (e.g., minimum and maximum values per column). In particular, as discussed, the underlying data may be stored in files that are written in a columnar format (e.g., Apache Parquet). A metadata layer may be implemented on top of these files that provides a structured, scalable way to organize and query the data—this metadata layer may reside between the data and query engine 155B. The metadata of this layer, in various embodiments, is stored as table format data 136. As an example, the metadata layer may be implemented using Apache Iceberg, and thus table format data 136 may include all the metadata (e.g., file locations, schema, portioning, snapshots, etc.) that is produced when using Apache Iceberg.

Unstructured data store 140, in various embodiments, is a database or a repository that stores unstructured data—that is, unstructured data store 140 may be used to manage data that lacks a predefined schema. Unstructured data store 140 might be implemented using an object storage system, such as Amazon S3. As shown, unstructured data store 140 includes content data 142 and search and vector data 144. Content data 142 may include text documents, images, videos, audio files, forum posts, product reviews, emails, web pages, sensor data, etc. Search and vector data 144, in various embodiments, includes high-dimensional vector data, such as embeddings or feature vectors that are numerical representations of objects (e.g., images, text, and audio files of content data 142) generated by machine learning models. Search and vector data 144 may further include graph data that defines graph-based data structures, where each node in a given graph-based data structure represents a vector and edges connect nearby vectors based on a similarity metric. This graph-based data structure may serve as an index that allows for vector embeddings to be found in an efficient manner. As an example, in a recommendation system, user or item embeddings may be indexed using a graph-based data structure to quickly find similar items for a given user query.

Query layer 150, in various embodiments, is a component or subsystem within system 100's architecture that is responsible for facilitating data retrieval, storage, and manipulation by providing a interface for submitting queries and receiving results. Query layer 150 may serve as an intermediary between users or applications (e.g., an LLM agent) and storage layer 105, managing the process of interpreting, optimizing, and executing queries to retrieve data efficiently and accurately. Accordingly, query layer 150 may translate high-level queries, which may be written in languages such as SQL or GraphQL, into operations that storage layer 105 can understand and process. In various embodiments, query layer 150 optimizes requests by leveraging indexing, caching, and query planning to minimize latency and resource usage. Query layer 150 may also coordinate requests across multiple nodes, aggregating results, and ensuring consistency. As shown, query layer 150 includes query engines 155A-C.

Query engines 155A-C, in various embodiments, are different instances of a software component/system that processes, optimizes, and executes queries against a data source, such as a database, a data warehouse, or a distributed storage system. Query engines 155A-C each can include a parser component that parses a query into an internal representation, an optimizer component that generates an execution plan (also referred to as a query plan) having steps for carrying out the query, an execution component that executes the plan, and a storage interface that allows the query engine to communicate with storage layer 105 to access data. In various embodiments, query engines 155A-C may be different types of query engines, where their type may be based on the corresponding store. For example, key-value store 120 may store data in a row format and be used for transactional processing. Accordingly, query engine 155A may be a relational database query engine, such as PostgreSQL®, that can access and process data from key-value store 120. Columnar store 130 stores data in a column format and may be used for analytical processing. Accordingly, query engine 155B may be a columnar database query engine, such as Apache Spark, that can access and process data from columnar store 130. Query engine 155C may be a query engine optimized for unstructured data, such as Elasticsearch®, that can access and process data from unstructured data store 140.

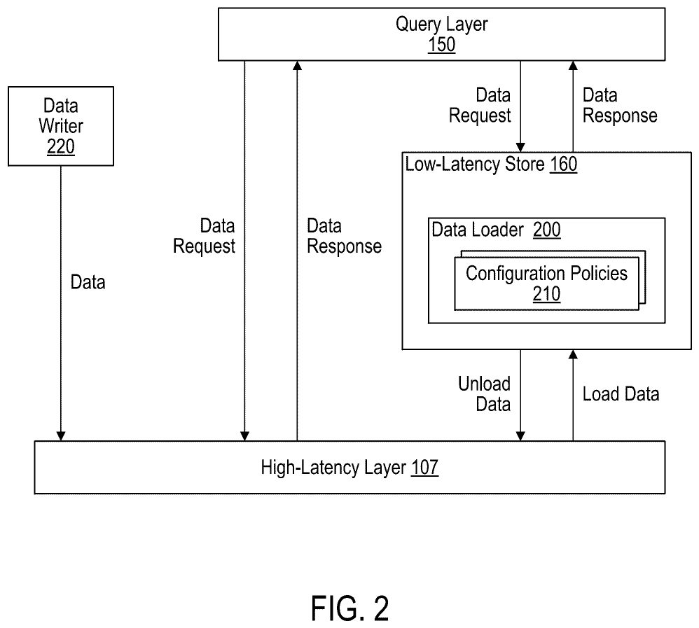

While not shown, query layer 150 may receive, from client applications (e.g., an LLM agent, a web application, or any other custom application) or users, requests to access data or write data to storage. A client application may be any type of application that interacts with query layer 150 to access, manipulate and store data at storage layer 105. Accordingly, query layer 150 may issue data requests to storage layer 105 to store or access data and receive data responses that include the requested data or indicate that the data has been stored. As discussed in greater detail with respect to FIG. 2, storage layer 105 may initially attempt to serve the requested data from low-latency store 160. But if the data is not present in low-latency store 160, then it may be accessed and returned from the appropriate store. For example, if an image is not cached at low-latency store 160, then it may be retrieved from unstructured data store 140 and returned to query layer 150 and ultimately the requesting client application or user.

Low-latency store 160, in various embodiments, is a store that can load data from high-latency layer 107 and provide that data in lower latency response times to data access requests than high-latency layer 107. As shown for example, low-latency store 160 includes key-value data 121, analytics data 131, and unstructured data 141 obtained from data ecosystems 110A-C, respectively. As discussed in greater detail with respect to FIG. 2, low-latency store 160 can use configuration policies to determine what data to load from high-latency layer 107 and how long to retain that data. In particular, low-latency store 160 may contain less storage than high-latency layer 107 and the total data that is stored by high-latency layer 107 may be greater than the available storage capacity of low-latency store 160. As a result, low-latency store 160 may selectively load data from high-latency layer 107 into low-latency store 160.

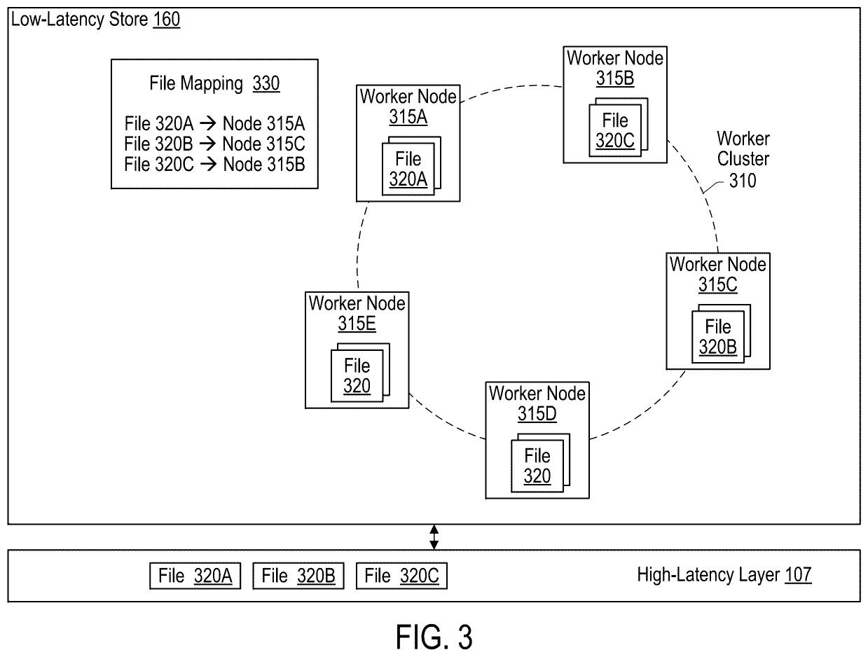

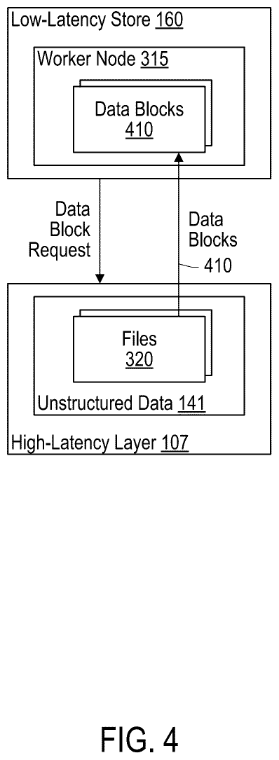

In various embodiments, low-latency store 160 may load and store data using different approaches or a combination of approaches. As discussed in greater detail with respect to FIG. 3, low-latency store 160 can implement a file addressing approach to load and store data across multiple nodes. Also, as discussed in greater detail with respect to FIG. 3, low-latency store 160 can be implemented across a cluster of worker nodes. The worker nodes may be coupled to NVMe drives that allow the worker processes on the nodes to access loaded structured and unstructured data with low latency (e.g., under one millisecond)—this stands in contrast to high-latency layer 107, which may leverage HDDs to store data and thus is not able to provide under one millisecond response times. As discussed in greater detail with respect to FIG. 4, low-latency store 160 can also implement a block addressing approach to load a subset of a total set of blocks that constitute a file. As a result, the entire file may not have to be loaded from underlying store into low-latency store 160. By leveraging a combination of approaches to load data, low-latency store 160 may cater to data of varying sizes (e.g., both small and large files).

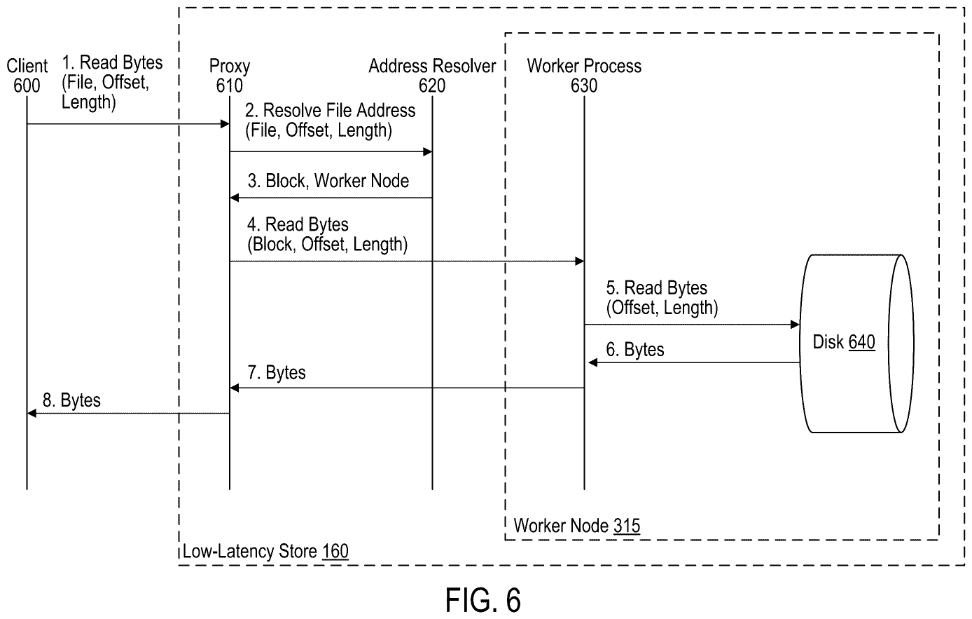

Since low-latency store 160 can load data from ecosystems 110A-C, low-latency store 160 serves as a single consolidated place from which the different types of data can be accessed by query layer 150. Thus, a single application programming interface (API) endpoint may be used to access different types of data. As a result, the complexity of accessing certain types of data by a component outside of storage layer 105 may be reduced as the component may need to only be programmed to access that single API endpoint. Said differently, because data from data ecosystems 110A-C may be accessed from a consolidated place, low-latency store 160, a component, such as query layer 150, does not have to reach out to multiple locations to obtain a mix of different types of data. As an example, if a client of query layer 150 attempts to access a portion of columnar data 132 and content data 142, query layer 150 may obtain that data by issuing data requests to only low-latency store 160 instead of having to issue separate requests to columnar store 130 and unstructured data store 140. An example of a client accessing data from low-latency store 160 is discussed in greater detail with respect to FIG. 6. By leveraging NVMe drives and loading data from different sources, in various embodiments, low-latency store 160 allows applications to access different types of data in real time (or close to real time) from a single consolidated place.

Turning now to FIG. 2, a block diagram of one embodiment in which low-latency store 160 includes a data loader 200 that can load data from high-latency layer 107 based on a set of configuration policies 210 is shown. In the illustrated embodiment, there is high-latency layer 107, query layer 150, low-latency store 160, and a data writer 220. Also as shown, low-latency store 160 includes data loader 200 with configuration policies 210. The illustrated embodiment may be implemented differently than shown. For example, data writer 220 may also write data to low-latency store 160 and/or data writer 220 may be part of query layer 150.

Data loader 200, in various embodiments, is software executable to load data into low-latency store 160 from high-latency layer 107 and also unload data from low-latency store 160 into high-latency layer 107. The operations of data loader 200 may be implemented by worker processes that execute on worker nodes of a worker node cluster, as discussed in greater detail with respect to FIG. 3. In various embodiments, data loader 200 implements a set of approaches to determine what data to load from or unload to high-latency layer 107. In some cases, data loader 200 may be provided with information that explicitly identifies the data. For example, one or more files may be written to or updated at high-latency layer 107. Data loader 200 may be provided with a list of the files (e.g., from a notification system that detects changes at high-latency layer 107) and load those files from high-latency layer 107 into low-latency store 160. Thus, when given a list of files, data loader 200 can orchestrate or implement the work that is needed to load them into low-latency store 160. Data loader 200 may also load data based on configuration policies 210.

A configuration policy 210, in various embodiments, defines a set of rules, settings, or parameters that identify or otherwise control what data to load into low-latency store 160. For example, a configuration policy 210 may indicate that WAL data 122 generated within the last seven days should be loaded into low-latency store 160. Thus, based on the policy, data loader 200 may load WAL data 122 generated within the last seven days. A configuration policy 210 may identify various properties such as the type(s) of data objects to load, the store from which to load them, a particular timeframe (e.g., within the last ten days) associated with the creation and/or modification of the data, how long to cache the data (e.g., retain for five days), and other conditional criteria (e.g., load rows that satisfy a conditional predicate (e.g., specify a value for a particular column), load files that contain certain text, load columnar data associated with a particular user or customer, etc.).

In various embodiments, configuration policies 210 are specified by tenants associated with system 100 (or subcomponents, such as data ecosystems 110A-C). For example, a tenant (e.g., company) may utilize an LLM agent of system 100 to interact with users (e.g., customers) of the tenant to provide certain services, such as customer support. In order to enable the LLM agent to provide more helpful responses to those users, the tenant may specify a configuration policy 210 that causes data loader 200 to load data graphs (that the tenant built on those users) from high-latency layer 107 into low-latency store 160, where a given data graph may capture the relationships and interactions between a user and other users, attributes, behaviors, or other relevant objects. By loading those data graphs into low-latency store 160, the LLM agent may be able to access them in real-time. Since different tenants can have different needs, each tenant may define different configuration policies 210 than other tenants, allowing for a tenant to load data that is relevant to their needs. In some cases, a provider of system 100 may define a set of configuration policies 210. As an example, configuration policies 210 may be defined to load any data that was recently generated and/or modified or that was generated and/or modified by a particular type of application. For example, if the LLM agent wrote data to high-latency layer 107 based on a request from a user, then that data may be loaded into low-latency store 160 as there may be a greater likelihood that it will be accessed in the near future.

Data may also be reloaded into low-latency store 160 in response to updates to the data at high-latency layer 107 by data writer 220. Data writer 220 may be an ingestion routine or a query engine 155 that can write and update data at high-latency layer 107. For example, data writer 220 may be a SQL database engine that manages database tables whose data is stored at key-value store 120. Accordingly, data writer 220 may update a row in a particular table, and the pre-update record of that row may be cached at low-latency store 160. Data loader 200 may detect that the row has been updated at key-value store 120 and load the post-update record of that row from key-value store 120 into low-latency store 160. Thus, in various embodiments, data loader 200 detects updates to data objects across data ecosystems 110A-C and reloads any updated data objects into low-latency store 160 that were previously cached. This process may be performed asynchronously after the data objects have been committed at the corresponding data ecosystem(s) 110.

In addition to loading data from high-latency layer 107, data loader 200 may also move data from low-latency store 160 into high-latency layer 107. For example, the LLM agent may write data into low-latency store 160 based on a request from a user, and low-latency store 160 may move that data to high-latency layer 107 if it has not been accessed after a period of time. In some embodiments, low-latency store 160 serves as a write-through storage. Accordingly, in response to a request to store data, low-latency store 160 may write that data to the relevant data ecosystem 110 before returning a response—low-latency store 160 may also cache a local copy of the data since it may be requested in the near future. In some embodiments, low-latency store 160 serves as a persistent store in certain cases. Accordingly, in response to a request to store data, low-latency store 160 may store the data without propagating the data to any of the data ecosystems 110A-C.

As shown, query layer 150 interacts with low-latency store 160 and high-latency layer 107. When accessing particular data, in various embodiments, query layer 150 attempts to first access that data from low-latency store 160 and falls back to high-latency layer 107 if that data is not available at low-latency store 160. A metadata catalog may be maintained that identifies what data is cached at low-latency store 160, and this catalog may be used by query layer 150 to determine whether to first issue a data request to low-latency store 160 or rather to proceed straight to high-latency layer 107. As an example, upon loading a file from unstructured data store 140, data loader 200 may update the catalog—which may be stored at low-latency store 160 and/or query layer 150—to indicate that the file is available at low-latency store 160. Thus, if query layer 150 is attempting to access that file, it can determine from the metadata catalog that the file is present at low-latency store 160 and therefore issue a data request to low-latency store 160 for the file.

But in some embodiments, a metadata catalog is not maintained and instead query layer 150 always attempts low-latency store 160 before falling back to high-latency layer 107 if the requested data is not available at low-latency store 160. Furthermore, in some embodiments, if requested data is not available at low-latency store 160 when receiving a data request from query layer 150, then data loader 200 loads the data from high-latency layer 107 and serves it from low-latency store 160 to query layer 150. As such, instead of falling back to high-latency layer 107, query layer 150 issues a request to low-latency store 160, and low-latency store 160 resolves the cache miss if the data is not present so that query layer 150 does not have to reach out to high-latency layer 107. In various embodiments, low-latency store 160 and high-latency layer 107 share a common API and endpoint for accessing data from storage layer 105. Thus, query layer 150 may issue data requests to the common endpoint, and an API component within storage layer 105 may route those requests to low-latency store 160 and high-latency layer 107 based on data availability at low-latency store 160. As such, the location of data across storage layer 105 may be hidden from query layer 150. Said differently, query layer 150 may not have to concern itself with whether to issue requests to low-latency store 160 or high-latency layer 107, rather it may issue data requests to a single endpoint while storage layer 105 takes care of the rest.

Turning now to FIG. 3, a block diagram of one embodiment of a file addressing approach that can be implemented by low-latency store 160 to load files 320 is shown. In the illustrated embodiment, there is high-latency layer 107 and low-latency store 160. As shown, high-latency layer 107 includes files 320A-C, and low-latency store 160 comprises a worker cluster 310 having worker nodes 315A-E that store files 320. Also as shown, low-latency store 160 includes a file mapping 330. The illustrated embodiment may be implemented differently than shown. For example, file mapping 330 may map data blocks of files 320 to nodes 315, as discussed in more detail with respect to FIG. 4. As another example, low-latency store 160 may include a proxy server that routes data requests to worker nodes 315-A-E.

Worker nodes 315A-E, in various embodiments, are virtual or physical machines that are coupled to or include storage devices that are utilized to store data loaded from high-latency layer 107. For example, worker nodes 315A-E may be virtual machines that are deployed onto a cloud platform (e.g., Amazon AWS®). Worker processes may execute on worker nodes 315 to load, unload, and manage the data of low-latency store 160—in various embodiments, these worker processes implement data loader 200. Worker nodes 315A-E may load and unload data based on configuration policies 210. As shown, worker nodes 315A-E store files 320 that are loaded from high-latency layer 107. Files 320 may include structured data and/or unstructured data. For example, files 320 may include Apache Parquet files that store columnar data 132, PDF files, video files, audio files, etc. To allow for parallelism and to reduce the workload that is placed on any one worker node 315, in various embodiments, files 320 are distributed across worker nodes 315A-E using a file addressing approach.

In various embodiments, this file addressing approach leverages consistent hashing to determine on which worker node 315 to store a given file 320. In this approach, nodes 315 and files 320 may be mapped to a fixed range of values—represented as a ring/circle—using a hash function, such as Secure Hash Algorithm 1 (SHA-1). In various embodiments, a hash value is generated based on a file 320, and then the hash value is used to determine the position of that file 320 on the ring. The hash value may be generated by performing the hash function on data of the file 320. For example, the file 320 may have a unique file identifier, and SHA-1 may be used to generate the hash value from the unique file identifier. In various embodiments, nodes 315 are placed around the ring and a file 320 is assigned to the first node encountered clockwise (or counterclockwise in other embodiments) from the file's position in the ring as determined from its hash value. For example, file 320C may hash to a position between worker node 315A and worker node 315B on the dashed ring of FIG. 3. Since worker node 315B is the first worker node 315 encountered going clockwise, file 320C is loaded onto worker node 315B. As such, in various embodiments, a worker process (or another other process of low-latency store 160 that can serve as an orchestrator process) performs a hash operation on data of a given file 320 to generate a hash value that is usable to determine a worker node 315 of worker cluster 310 on which to store the file 320; and then that file 320 is loaded on the worker node 315. In order to determine later where a file 320 is stored (e.g., when a data request is received), low-latency store 160 maintains file mapping 330.

File mapping 330, in various embodiments, is information that maps files 320 to worker nodes 315. As shown, files 320A-C are respectively stored on worker node 315A, 315C, and 315. Accordingly, file mapping 330 maps file 320A to worker node 315A, file 320B to worker node 315C, and file 320C to worker node 315B. In some embodiments, file mapping 330 maps data blocks that make up files 320 to worker nodes 315A-E—data blocks are discussed in more detail with respect to FIG. 4. In addition to mapping files and/or data blocks to worker nodes 315A-E, file mapping 330 may map other data, such as LSM structures, log records, machine learning embeddings, etc., to worker nodes 315. Accordingly, when servicing data requests to access particular data, low-latency store 160 may utilize file mapping 330 to determine which worker node(s) 315 store the requested data. Low-latency store 160 may route the requests to those worker nodes 315 and their responses back to the requesting entity.

Turning now to FIG. 4, a block diagram of one embodiment of a block-based addressing approach that can be implemented by low-latency store 160 to load files 320 is shown. In the illustrated embodiment, there is high-latency layer 107 and low-latency store 160. As shown, high-latency layer 107 includes unstructured data 141 having files 320, and low-latency store 160 includes a worker node 315 that accesses data blocks 410 from files 320. The illustrated embodiment may be implemented differently than shown. For example, high-latency layer 107 may also store structured data in files 320—e.g., columnar data 132 may be stored in files.

In various cases, high-latency layer 107 stores files 320 that are large in size. Loading these large files 320 into the disk(s) associated with worker node 315 may be a time consuming process, and often only a portion of a file 320 is actually used by an application. For example, a file 320 may include information about multiple users, but an LLM agent may be interested in only the information of a particular user. As a result, loading the entirety of a large file 320 can also be inefficient. Accordingly, in order to be better suited for loading files 320, in various embodiments, worker node 315 implements a block-based addressing approach in which only a subset of a total set of data blocks 410 that constitute a file 320 may be loaded.

Instead of storing a file 320 as a single contagious chunk, the file 320 may be split into smaller chunks or data blocks 410. For example, a file 320 that is 512 megabytes (MBs) may be divided and stored as eight data blocks 410 that are 64 MBs in size. In various embodiments, each data block 410 is assigned a unique address that allows for the individual data block 410 to be accessed independent of other data blocks 410. Storage layer 105 may maintain metadata, such as an index or a file allocation table, that tracks the addresses of the data blocks 410 that constitute a given file 320—in some cases, this metadata may be stored as part of file mapping 330.

Using configuration policies 210, worker node 315 may determine a subset of a total set of data blocks 410 that constitute a file 320 to load from high-latency layer 107 into a low-latency store 160. For example, a configuration policy 210 may specify that user information generated within the last seven days for a particular tenant should be loaded. A large file 320 may store user information for the last 30 days. Accordingly, worker node 315 may determine an offset address in the file 320 from which to start loading data. Based on that offset address, worker node 315 may determine a starting data block 410 (e.g., the data block 410 having the closest address before or at the offset address) and load one or more data blocks 410, beginning with the starting data block 410. In various embodiments, worker node 315 sends the addresses of the one or more data blocks 410 to high-latency layer 107 in data block requests and receives the one or more data blocks 410. Accordingly, worker node 315 may load only a subset of the data blocks 410 of the file 320 into low-latency store 160 without loading the remaining data blocks 410 of the total set of data blocks 410. In some cases, an application may request (e.g., via query layer 150) a subset of data blocks 410, where the request may specify an offset and a byte length. Worker node 315 may use this information to load the subset of data blocks 410 and return them to the application, improving efficiency and reducing resource usage compared to loading the entire file 320.

Furthermore, by splitting a file 320 into data blocks 410, a file 320 may be stored across multiple worker nodes 315. For example, a file 320 that is divided into eight data blocks 410 may be stored across eight different worker nodes 315. Accordingly, a subset or all data blocks 410 of a file 320 may be loaded across worker nodes 315 of worker cluster 310, and a mapping, such as file mapping 330, may be maintained between worker nodes 315 and data blocks 410 of a given file 320. When a data request for a subset or all data blocks 410 of a certain file 320 is received, the request may be routed (e.g., by a proxy server) to the appropriate worker nodes 315, which may access and return the requested data blocks 410. By distributing data blocks 410 (or more broadly, a file 320) across multiple worker nodes 315, this may enable parallelism and also reduce the workload placed on any single worker node 315.

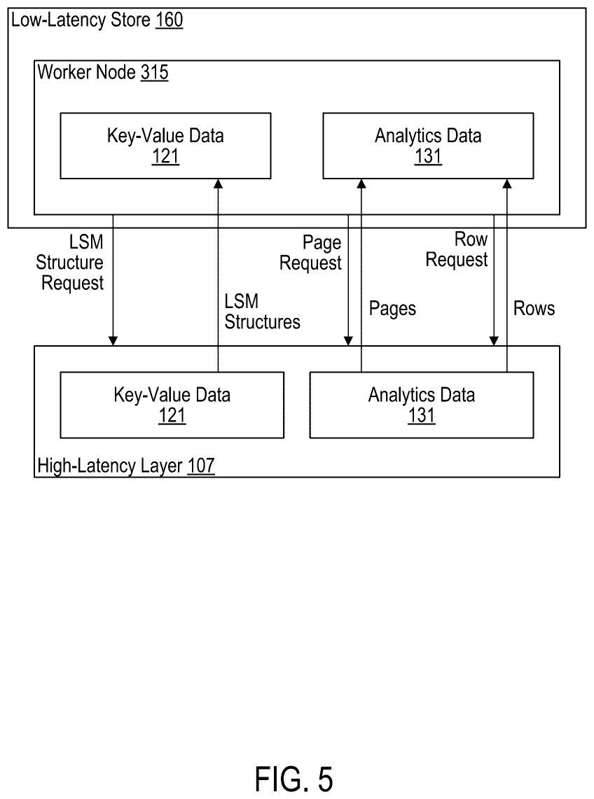

Turning now to FIG. 5, a block diagram of one embodiment of an approach that can be implemented by low-latency store 160 to load different types of structured data is shown. In the illustrated embodiment, there is high-latency layer 107 and low-latency store 160. Also as shown, high-latency layer 107 includes key-value data 121 and analytics data 131, and low-latency store 160 includes a worker node 315 that loads at least a portion of key-value data 121 and at least a portion of analytics data 131. The illustrated embodiment may be implemented differently than shown. For example, worker node 315 may load entire files of structured data, such as an Apache Parquet file that may store columnar data 132.

As discussed, key-value data 121 can include WAL data 122 that comprises log records and LSM tree data 124 that includes various LSM structures, such as SSTables, spare indexes, manifest files, etc. In various embodiments, worker node 315 can load (and unload) log records and entire LSM structures. As an example, a configuration policy 210 may cause worker node 315 to load one or more SSTables from high-latency layer 107 (key-value store 120) into low-latency store 160. Thus, worker node 315 may issue LSM structure requests and receive LSM structures in response, as shown. An application may then request these LSM structures, and worker node 315 may serve them with lower latency than the application accessing them from high-latency layer 107.

As discussed, analytics data 131 may be stored in one or more files 320. For example, columnar data 132 may be stored in Apache Parquet files. When accessing data from the files, worker node 315 may issue page requests to access particular pages of these files and receive them, as shown. In some embodiments, a page of a file may correspond to a particular column of the underlying data structure. Accordingly, when loading the column's data into low-latency store 160, worker node 315 may leverage metadata to locate the relevant page while skipping irrelevant pages that correspond to other columns, reducing the amount of data that is loaded. Also, as shown, worker node 315 can load analytics data 131 at the row level. As discussed, in various embodiments, columnar store 130 can reconstruct rows from columnar data 132 and return the rows in response to row requests for them. As a result, applications that want to use columnar data 132 but benefit from a row format are able to access columnar data 132 in a row format from low-latency store 160.

Turning now to FIG. 6, a diagram of one embodiment of low-latency store 160 servicing a data request from a client 600 is shown. In the illustrated embodiment, there is low-latency store 160 and client 600. As shown, low-latency store includes a proxy 610, an address resolver 620, and worker node 315. As further shown, worker node 315 includes a worker process 630 and a disk 640. The illustrated embodiment may be implemented differently than shown. For example, client 600 may issue a request that specifies a key associated with a record included in key-value data 121.

As shown, client 600 initially issues a data request to proxy 610 to read particular bytes, where the request specifies a file (e.g., a file 320), an offset in the file, and the length/amount of data to read and return. Client 600 may be any of various applications or systems that seek data from low-latency store 160. For example, client 600 may be a query engine 155 of query layer 150, a machine learning application (which may interact with low-latency store 160 via query layer 150), a user device of a user associated with system 100, etc. Proxy 610, in various embodiments, is a server that acts as an intermediary between client 600 and the components of low-latency store 160. Proxy 610 may perform various functions such as loading balancing, protecting components, such as address resolver 620 and worker process 630, from malicious requests, connection management, etc.

Proxy 610 can receive requests from client 600, forward them to the appropriate worker nodes 315, and relay their responses to client 600. Accordingly, as shown, proxy 610 performs an address resolution step by making a call to address resolver 620. Address resolver 620, in various embodiments, is a process or system that determines which worker node 315 stores the data (the file) requested by client 600 (e.g., by using file mapping 330 to translate a file ID into a node ID). Address resolver 620 can further determine relevant data blocks. Accordingly, as shown, address resolver 620 returns, to proxy 610, information that identifies worker node 315 and one or more blocks. Proxy 610 issues a request to worker process 630 to read particular bytes, where the request specifies the one or more blocks, the offset, and the length/amount of data to read and return.

After receiving the request, worker process 630 then accesses the requested bytes from disk 640 based on the offset and length, as shown. Worker process 630 may be a process that, as discussed with respect to FIG. 3, implements data loader 200 to load data from high-latency layer 107 into low-latency store 160, and disk 640 may be an NVMe drive. After reading the bytes from disk 640, worker process 630 returns them to proxy 610, and proxy 610 then returns them to client 600, completing the initial data request. In various embodiments, this process of retrieving the data takes less time than retrieving the data from high-latency layer 107—e.g., a millisecond versus 100s of milliseconds.

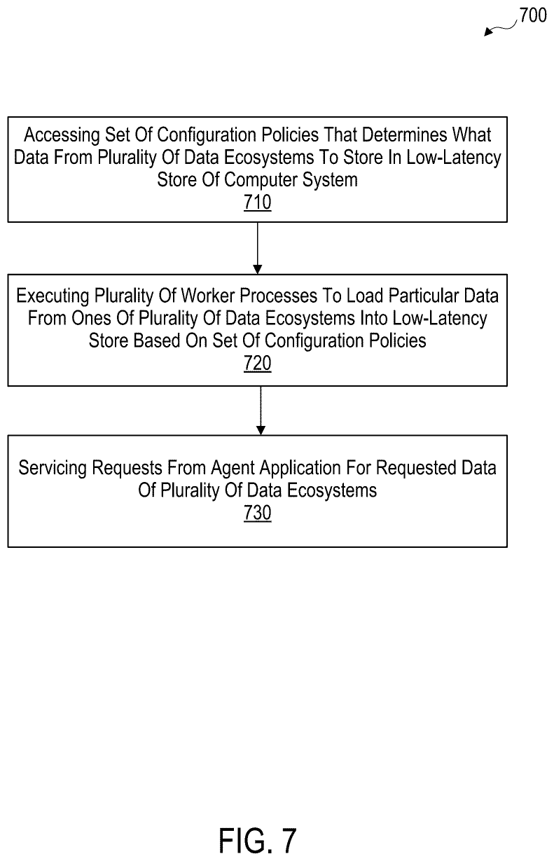

Turning now to FIG. 7, a flow diagram of a method 700 is shown. Method 700 is one embodiment of a method that is performed by a computer system (e.g., system 100, a system implementing low-latency store 160, etc.) to serve, from a low-latency store (e.g., low-latency store 160), data that originates from different data ecosystems (e.g., data ecosystems 110A-C). Method 700 may be performed by executing program instructions stored on a non-transitory computer-readable medium. Method 700 may include more or fewer steps than shown. For example, method 700 may include a step in which the computer system receives configuration policies (e.g., configuration policies 210) from tenants of the computer system.

Method 700 begins in step 710 with the computer system accessing a set of configuration policies that determines what data from a plurality of data ecosystems (e.g., data ecosystems 110A-C) to store in the low-latency store of the computer system. In various embodiments, at least two of the plurality of data ecosystems include different database systems (e.g., query engine 155A with key-value store 120, query engine 155B with columnar store 130, etc.) that store data differently. At least one of the plurality of data ecosystems may include structured data (e.g., columnar data 132) and at least one data ecosystem may include unstructured data (e.g., content data 142). The set of configuration policies may include a configuration policy that a particular type of data object created within a particular timeframe (e.g., last seven days) be loaded into the low-latency store. In various embodiments, the set of configuration policies includes configuration policies defined by different tenants associated with the plurality of data ecosystems.

In step 720, the computer system executes a plurality of worker processes (e.g., worker processes on worker nodes 315) to load particular data from ones of the plurality of data ecosystems into the low-latency store based on the set of configuration policies. The particular data may include unstructured and structured data. In various embodiments, the unstructured data of the particular data includes a plurality of files (e.g., files 320) loaded by ones of the plurality of worker processes using different approaches that account for different file sizes. The different approaches may include a block approach that involves, for a particular one of the plurality of files, determining a subset of a total set of data blocks constituting the particular file and then loading only the subset of data blocks of the particular file into the low-latency store without loading remaining data blocks of the total set of data blocks. The different approaches may include a placement or file addressing approach that involves, for a particular one of the plurality of files, performing a hash operation on particular data of the particular file to generate a hash value that is usable to determine a particular one of a plurality of nodes (e.g., worker nodes 315) of the computer system on which to store the particular file and then storing the particular file on the particular node. The block approach and the placement approach may be performed together. In various embodiments, for the placement approach, the computer system maintains a mapping (e.g., file mapping 330) between ones of the plurality of nodes and ones of the plurality of files.

In step 730, the computer system services requests from a client application for data of the plurality of data ecosystems. The servicing includes accessing and returning at least a portion of the requested data from the low-latency store instead of one or more of the plurality of data ecosystems. The servicing of the requests may include using the mapping to determine on which ones of the plurality of nodes are stored one or more files requested by ones of the requests. The low-latency store provides lower latency response times to data access requests than ones of the plurality of data ecosystems. In various embodiments, the particular data of the low-latency store is stored on storage devices (e.g., NVMe) that have lower latency access times than storage devices (e.g., HDD) used to store data of at least one of the plurality of data ecosystems. The low-latency store and the plurality of data ecosystems may be accessible via the same application programming interface endpoint. The client application may be a machine learning application (e.g., an LLM agent) that accesses particular unstructured and structured data from the low-latency store via the requests.

The particular data may include a particular data object that is stored at one of the plurality of data ecosystems. The computer system may detect that the particular data object has been updated at the data ecosystem and then reload the particular data object from the data ecosystem into the low-latency store. The computer system may also receive, from the client application, a set of requests to store, in the low-latency store, data that is generated by the client application. Accordingly, the computer system may store the generated data in the low-latency store without propagating the generated data to any of the plurality of data ecosystems. In some cases, the computer system may propagate the generated data upon receiving it (thus the low-latency store serving as write-through storage) or after a period of time (e.g., after the generated data has not been requested in the last two hours).

### Exemplary Computer System

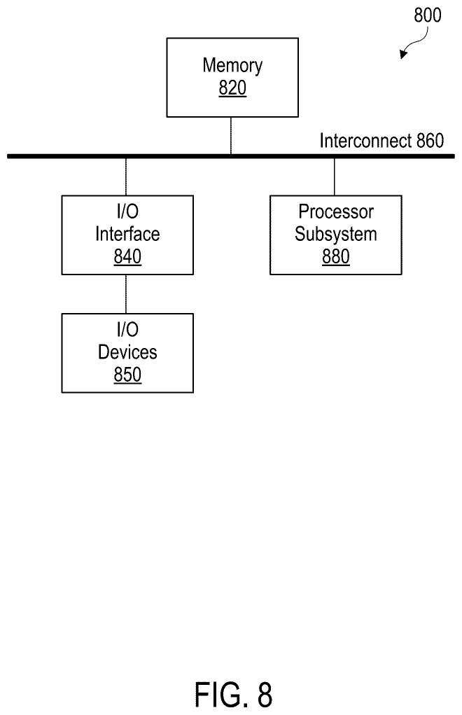

Turning now to FIG. 8, a block diagram of an exemplary computer system 800, which may implement system 100, storage layer 105, low-latency layer 106, high-latency layer 107, data ecosystems 110A-C, query layer 150, and/or low-latency store 160, is depicted. Computer system 800 includes a processor subsystem 880 that is coupled to a system memory 820 and I/O interfaces(s) 840 via an interconnect 860 (e.g., a system bus). I/O interface(s) 840 is coupled to one or more I/O devices 850. Although a single computer system 800 is shown in FIG. 8 for convenience, system 800 may also be implemented as two or more computer systems operating together.

Processor subsystem 880 may include one or more processors or processing units. In various embodiments of computer system 800, multiple instances of processor subsystem 880 may be coupled to interconnect 860. In various embodiments, processor subsystem 880 (or each processor unit within 880) may contain a cache or other form of on-board memory.

System memory 820 is usable store program instructions executable by processor subsystem 880 to cause system 800 perform various operations described herein. System memory 820 may be implemented using different physical memory media, such as hard disk storage, floppy disk storage, removable disk storage, flash memory, random access memory (RAM—SRAM, EDO RAM, SDRAM, DDR SDRAM, RAMBUS RAM, etc.), read only memory (PROM, EEPROM, etc.), and so on. Memory in computer system 800 is not limited to primary storage such as memory 820. Rather, computer system 800 may also include other forms of storage such as cache memory in processor subsystem 880 and secondary storage on I/O Devices 850 (e.g., a hard drive, storage array, etc.). In some embodiments, these other forms of storage may also store program instructions executable by processor subsystem 880. In some embodiments, program instructions that when executed implement key-value store 120, columnar store 130, unstructured data store 140, low-latency store 160, data loader 200, data writers 220, and/or worker nodes 315 may be included/stored within system memory 820.

I/O interfaces 840 may be any of various types of interfaces configured to couple to and communicate with other devices, according to various embodiments. In one embodiment, I/O interface 840 is a bridge chip (e.g., Southbridge) from a front-side to one or more back-side buses. I/O interfaces 840 may be coupled to one or more I/O devices 850 via one or more corresponding buses or other interfaces. Examples of I/O devices 850 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 800 is coupled to a network via a network interface device 850 (e.g., configured to communicate over Wi-Fi, Bluetooth, Ethernet, etc.).

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
accessing, by a computer system, a set of configuration policies that determines what data from a plurality of data ecosystems to store in a low-latency store of the computer system, wherein at least two of the plurality of data ecosystems include different database systems that store data differently, and wherein at least one of the plurality of data ecosystems includes structured data and at least one of the plurality of data ecosystems includes unstructured data;
executing, by the computer system, a plurality of worker processes to load particular data from ones of the plurality of data ecosystems into the low-latency store based on the set of configuration policies, wherein the particular data includes unstructured and structured data, and wherein the unstructured data of the particular data includes a plurality of files loaded by ones of the plurality of worker processes using different approaches that account for different file sizes; and
servicing, by the computer system, requests from a client application for requested data of the plurality of data ecosystems, wherein the servicing includes accessing and returning at least a portion of the requested data from the low-latency store instead of one or more of the plurality of data ecosystems, and wherein the low-latency store provides lower latency response times to data access requests than ones of the plurality of data ecosystems.

2. The method of claim 1, wherein the different approaches include a block approach that includes, for a particular one of the plurality of files:
determining a subset of a total set of data blocks that constitute the particular file; and
loading only the subset of data blocks of the particular file into the low-latency store without loading remaining data blocks of the total set of data blocks.

3. The method of claim 1, wherein the different approaches include a placement approach that includes, for a particular one of the plurality of files:
performing a hash operation on particular data of the particular file to generate a hash value that is usable to determine a particular one of a plurality of nodes of the computer system on which to store the particular file; and
storing the particular file on the particular node.

4. The method of claim 3, further comprising:
maintaining, by the computer system, a mapping between ones of the plurality of nodes and ones of the plurality of files,
wherein the servicing of the requests includes using the mapping to determine on which ones of the plurality of nodes are stored one or more files requested by ones of the requests.

5. The method of claim 1, wherein the set of configuration policies includes configuration policies defined by different ones of a plurality of tenants associated with the plurality of data ecosystems.

6. The method of claim 1, wherein the set of configuration policies include a configuration policy that a particular type of data object created within a particular timeframe be loaded into the low-latency store.

7. The method of claim 1, wherein the particular data includes a particular data object that is stored at one of the plurality of data ecosystems, and wherein the method further comprises:
detecting, by the computer system, that the particular data object has been updated at the data ecosystem; and
reloading, by the computer system, the particular data object from the data ecosystem into the low-latency store.

8. The method of claim 1, wherein the particular data of the low-latency store is stored on storage devices that have lower latency access times than storage devices used to store data of at least one of the plurality of data ecosystems.

9. The method of claim 1, wherein the client application is a machine learning application that accesses particular unstructured and structured data from the low-latency store via the requests.

10. The method of claim 1, wherein the low-latency store and the plurality of data ecosystems are accessible via a same application programming interface endpoint.

11. A non-transitory computer-readable medium having program instructions stored thereon that are capable of causing a computer system to perform operations comprising:
accessing a set of configuration policies that determines what data from a plurality of data ecosystems to store in a low-latency store of the computer system, wherein at least two of the plurality of data ecosystems include different database systems that store data differently, and wherein at least one of the plurality of data ecosystems includes structured data and at least one of the plurality of data ecosystems includes unstructured data;
executing a plurality of worker processes to load particular data from ones of the plurality of data ecosystems into the low-latency store based on the set of configuration policies, wherein the particular data includes a plurality of files loaded by ones of the plurality of worker processes using different approaches that account for different file sizes; and
servicing requests for requested data of the plurality of data ecosystems, wherein the servicing includes accessing and returning at least a portion of the requested data from the low-latency store instead of one or more of the plurality of data ecosystems, and wherein the low-latency store provides lower latency response times to data access requests than ones of the plurality of data ecosystems.

12. The non-transitory computer-readable medium of claim 11, wherein loading of a set of the plurality of files includes, for a given one of the set of files:
determining a subset of a total set of data blocks that constitute the given file; and
loading the subset of data blocks into the low-latency store without loading remaining data blocks of the total set of data blocks that constitute the given file.

13. The non-transitory computer-readable medium of claim 11, wherein loading of a set of the plurality of files includes, for a given one of the set of files:
performing a hash operation on particular data of the given file to generate a hash value that is indicative of a particular one of a plurality of nodes of the computer system on which to store the given file; and
storing the given file on the particular node.

14. The non-transitory computer-readable medium of claim 11, wherein the operations further comprise:
receiving, from a client application, a set of requests to store, in the low-latency store, data generated by the client application; and
storing the generated data in the low-latency store without propagating the generated data to any of the plurality of data ecosystems.

15. The non-transitory computer-readable medium of claim 11, wherein the operations further comprise:
detecting that a particular object loaded into the low-latency store has been updated to an updated version at a particular one of the plurality of data ecosystems; and
replacing the particular object at the low-latency store with the updated version of the particular object from the particular data ecosystem.

16. A system, comprising:
at least one processor; and
memory having program instructions stored thereon that are executable by the at least one processor to cause the system to perform operations comprising:
accessing a set of configuration policies that determines what data from a plurality of data ecosystems to store in a low-latency store of the system, wherein at least two of the plurality of data ecosystems include different database systems that store data differently, and wherein at least one of the plurality of data ecosystems includes structured data and at least one of the plurality of data ecosystems includes unstructured data;
executing a plurality of worker processes to load particular data from ones of the plurality of data ecosystems into the low-latency store based on the set of configuration policies, wherein the particular data includes a plurality of files loaded by ones of the plurality of worker processes using different approaches that account for different file sizes; and
servicing requests for requested data of the plurality of data ecosystems, wherein the servicing includes accessing and returning at least a portion of the requested data from the low-latency store instead of one or more of the plurality of data ecosystems, and wherein the low-latency store provides lower latency response times to data access requests than ones of the plurality of data ecosystems.

17. The system of claim 16, wherein loading of a set of the plurality of files includes, for a given one of the set of files:
determining a subset of a total set of data blocks that constitute the given file; and
loading the subset of data blocks into the low-latency store without loading remaining data blocks of the total set of data blocks that constitute the given file.

18. The system of claim 16, wherein loading of a set of the plurality of files includes, for a given one of the set of files:
performing a hash operation on particular data of the given file to generate a hash value that is indicative of a particular one of a plurality of nodes of the system on which to store the given file; and
storing the given file on the particular node.

19. The system of claim 18, wherein the operations further comprise:
maintaining a mapping between ones of the plurality of nodes and ones of the set of files,
wherein the servicing of the requests includes using the mapping to determine on which ones of the plurality of nodes are stored one or more files requested by ones of the requests.

20. The system of claim 16, wherein the operations further comprise:
detecting that a particular object loaded into the low-latency store has been updated to an updated version at a particular one of the plurality of data ecosystems; and
replacing the particular object at the low-latency store with the updated version of the particular object from the particular data ecosystem.
